(19) United States
(12) Patent Application Publication
(10) Pub. No.: US 2008/0204481 A1
(43) Pub. Date: Aug. 28, 2008

(54) Device and Method for Controlling a Backlit Display

(75) Inventor: Roman Mostinski, Jerusalem (IL)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 11/911,929

(22) PCT Filed: Apr. 20, 2005
(86) PCT No.: PCT/IB2005/051292

§ 371 Date: Oct. 18, 2007

(51) Int. Cl. G09G 5/02; G09G 3/36

(52) U.S. Cl. 345/690; 345/102; 345/87; 345/101

(57) ABSTRACT

A device and method for controlling a display. The method includes: receiving image data, determining backlight illumination intensity in response to an allowed image degradation level parameter and to ambient light, and determining a display refresh parameter in response to a temperature parameter.

A method and device for controlling a display, the device includes: a frame buffer adapted to receive image data, a processor adapted to receive a power parameter and an allowed image degradation level parameter, and an image converter that is adapted to perform a linear image conversion and a non-linear image conversion. The processor is adapted to determine which conversion to perform in response to a power parameter.

### FIELD OF THE INVENTION

The present invention relates to devices and methods for controlling a display, and especially for controlling a backlit display.

### BACKGROUND OF THE INVENTION

Battery operated devices, such as cellular phones, radios, MP3 players, personal data appliances, pagers and small sized computers are required to operate for relatively long periods before being recharged.

Modern mobile devices are required to provide high quality display of various types of images in various ambient light conditions.

Many mobile devices have Liquid crystal display (LCD) screens. There are three main types of LCD screens-reflective LCDs, transmissive LCDs and transflective LCDs.

Reflective LCDs include a LCD layer that selectively, in dependence of electrical control signals, reflects either ambient light and/or light from a front-light element. Using only ambient light can save energy but also reduces the image quality in low ambient light conditions. Accordingly, many reflective LCDs have a front-light element.

Backlit LCDs include a backlighting element and a selectively transparent, in dependence of electrical control signals, LCD layer. The light from the backlighting element selectively passes through the thin LCD layer to provide an image.

Transflective LCDs are partially transmissive and partially reflective. Their LCD layer usually reflects accident light, either ambient or from a front lighting element and transmits light from a backlighting element.

Most small-sized mobile devices use transflective backlit LCDs. The backlighting element is energy consuming. In order to reduce the energy consumption of backlit LCD various energy reduction techniques were provided. The most known technique includes dimming the backlight source by a while increasing the transparency of the LCD layer. Said transparency increment is achieved by increasing (boosting) the values of the image pixels.

U.S. patent application 2004/0113906 of Lew at el., titled “Backlight dimming and LCD amplitude boost”, which is incorporated herein by reference describes certain methods and apparatuses for dimming a backlight light source while boosting pixel values.

U.S. patent application 2004/0160435 of Cui et al. titled “Real-time dynamic design of liquid crystal display (LCD) panel power management through brightness control”, which incorporated herein by reference, describes a method and system that perform image conversion based upon a segment mode (which bits out of multiple bits representing a color component shall be selected)and a predefined threshold.

European patent application EP1291842A1 titled “Control method for a cold start of a liquid crystal display and control unit therefore”, which is incorporated herein by reference, describes a method for enhancing the response time of a liquid crystal display by measuring the temperature of material forming part of the display, applying a drive voltage control signal to the LCD at a selected frame refresh frequency depending upon the measured temperature.

The article titled “Low-Power Color TFT LCD Display for Hand-Held Embedded Systems”, by I. Choi, H. Shim and N. Chang, ISLPED 2002, Aug. 12-14, 2002, Monterey, Calif., U.S.A., which is incorporated herein by reference described various alternative power reduction methods such as reducing duty cycle refresh rate, dynamic color depth and backlight dimming with brightness or edge enhancement.

U.S patent application publication number 2002/0180744 of Takala et el titled “Display frame buffer update method and device” describes a method for minimizing display buffer updates offering power savings for mobile devices as an alternative to periodical display buffer update.

The article titled “A Backlight Power Management Framework for Battery-Operated Multimedia Systems”, by H. Shim and M. Pedram, IEEE Design & Test of Computers, 2004, which is incorporated herein by reference, describes a device and a method that select between dynamic luminance scaling (pixel boosting and backlight source dimming) and dynamic contrast enhancement.

The article titled “HEBS” Histogram Equalization for Backlight Scaling”, by A. Iranli, H. Fatemi, and M. Pedram, which is scheduled to appear in Proc. of Design Automation and Test in Europe, March 2005, which is incorporated herein by reference, describes various image conversion processes, based upon processing of the image histogram.

There is a need to provide an efficient method and device for controlling a display.

### SUMMARY OF THE PRESENT INVENTION

A method and a device for controlling a display, as described in the accompanying claims.

### BRIEF DESCRIPTION OF THE DRAWINGS

The present invention will be understood and appreciated more fully from the following detailed description taken in conjunction with the drawings in which:

FIG. 1 illustrates a device for controlling a display, as well as the display, according to an embodiment of the invention;

FIG. 2 illustrates a method for controlling a display, according to an embodiment of the invention;

FIG. 3 illustrates a method for controlling a display, according to another embodiment of the invention;

FIG. 4 illustrates an image conversion process, according to an embodiment of the invention; and

FIG. 5 illustrates exemplary histograms of an image and of a converted image.

### DETAILED DESCRIPTION OF PREFERRED EMBODIMENTS

The following figures illustrate exemplary embodiments of the invention. They are not intended to limit the scope of the invention but rather assist in understanding some of the embodiments of the invention.

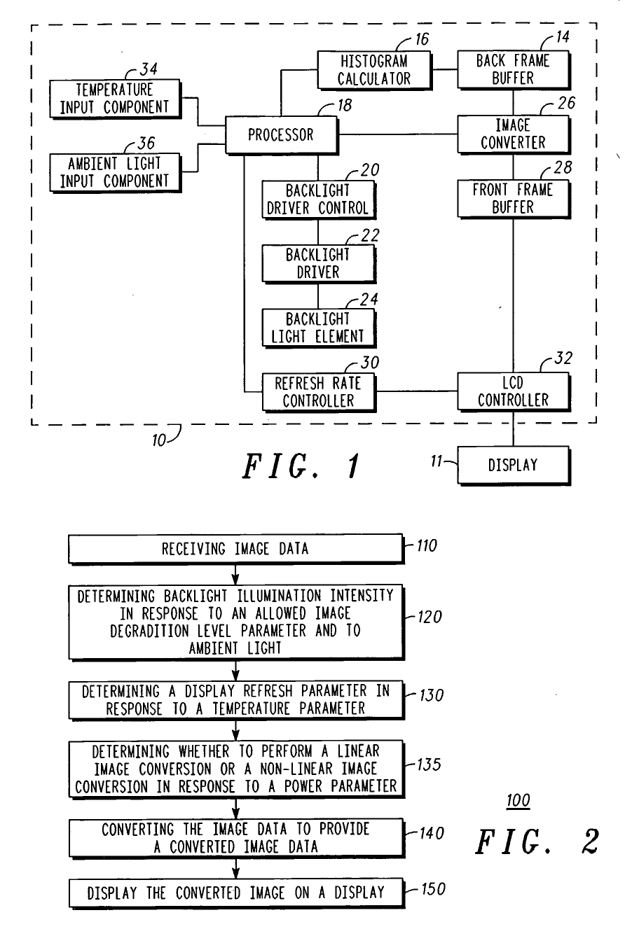

It is further noted that FIG. 1-5 are out of scale. The order of various stages in methods and processes as illustrated in any of FIGS. 2-4 is not limiting. Some stages can be executed in parallel to other stages while stages that are illustrated as following certain stages can preceded them.

According to an embodiment of the invention various dedicated hardware components perform various processes, especially per pixel operations. On the other hand while global (of frame based) processes, such as determining global parameters (including, for example, backlight intensity dimming, setting low and high pixel value thresholds, and the like) are performed by a processor.

Conveniently, various processes can be performed by one or more software components that are not part of the operating system. For example, these processes can be controlled or executed by a device driver software. Thus, the display is controlled in a manner that is transparent to an operation system of an integrated chip and is transparent to an application layer software.

The following description refers to the RGB (red, green and blue) color space, although is can be applied to other color spaces. It is further noted that the device and method can perform color space conversion, image compression, image de-compression, and other operations without departing from the scope of the invention.

FIG. 1 illustrates a device 10 for controlling a display 11, as well as the display 11, according to an embodiment of the invention

Device 10 is usually a part of a mobile device, such as but not limited to a cellular phone. The mobile device has a battery and is capable of monitoring the battery and providing a rest of battery charge parameter, hereinafter power parameter. The mobile device further include temperature and ambient light sensors (not shown), for sensing ambient light and either ambient or display temperature.

Device 10 includes a back frame buffer 14, a histogram calculator 16, processor 18, backlight driver controller 20, backlight driver 22, backlight light source 24, image converter 26, front frame buffer 28, LCD refresh rate controller 30, a LCD controller 32, a temperature input component 34 and an ambient light input component 36. It is noted that some of all of the components can be integrated, and that device 10 can include other components.

These hardware components are usually a part of an integrated circuit, such as a multi-media chip. The multi-media chip can include multiple processors, can be a system on chip, but this is not necessarily so.

The processor 18 can perform various tasks, such as tasks that are not related to the display 11 or backlight source 24. The processor 18 can be a general purpose processor, a digital signal processor and the like. Conveniently, processor 18 is capable of executing various software components.

Conveniently, processor 18 receives from operator or from external software components, an allowed image degradation level parameter, a power parameter, an ambient light parameter and a temperature parameter. The processor 18 determines one or more display refresh parameters and determines a backlight illumination intensity in response to the received parameters.

The allowed image degradation level parameter usually defines the ratio between the number of pixels outside the dynamic range in use (defined by THhigh and THlow) and the number of possible pixel values. The ambient light parameter usually represents the ambient light intensity. The at least one display refresh parameter usually defines a minimal refresh rate and a maximal refresh rate.

According to an embodiment of the invention the processor 18 can also determine whether to perform a linear image conversion or a non-linear image conversion, and also determine various parameters (such as histogram dynamic range, histogram granularity)and the like.

Conveniently, the linear image conversion keeps the image color distribution and contrast close to original, consumes less power and is simpler than the non-linear image conversion, but provides a lower visibility with the same backlight dim level, or provides the same visibility while lower dim of backlight, and so, enables power saving lower than non-linear does. It is noted that a linear conversion includes applying a liner operation on pixel values that belong to a pixel value dynamic range.

It is noted that a linear conversion can also include truncation as well as mapping various pixel values outside the dynamic range to certain predefined pixel values, such as a high pixel value threshold THhigh and a low pixel value threshold THlow.

The processor 18 can also determine whether to perform edge accentuation or not. An edge can be determined in various manners, including comparing the difference between the values of adjacent pixels. The inventors applied a Laplacian operator, but this not necessarily so. In mathematical terms, assuming that p(i,j) is a pixel and that an edge accentuated pixel p′(i,j) then:

p′(i,j)=p(i,j)−k×∇²p(i,j)

The back frame buffer 14 receives image data that has to be displayed by display 11. The back frame data 14 can be accessed by various components such as but not limited to histogram calculator 16 and image converter 26. The histogram calculator is capable of calculating a histogram of the image data.

According to an embodiment of the invention the histogram calculator 16 can operate in various manners that differ from each other by the truncation (or grouping) level of pixels. If, for example, each pixel can have 2ⁿ values then a reduced histogram includes 2^{k} pixel groups (also called bins) whereas k<n. Typical values of n and k are 16 and 12, but other values can be selected.

According to another embodiment of the invention the histogram calculator 16 performs a fixed truncation function. Thus, instead of being able to select k, k is fixed.

According to an embodiment of the invention the histogram calculator 16 further maps pixels of the original images to the dynamic range. THhigh and THlow are responsive to the allowed image degradation level parameter. Typically, a user can define the allowed image degradation level parameter. Conveniently, this parameter is sent to the processor 18.

It is noted that device 10 can generate a truncated histogram (by mapping 2ⁿ possible pixel values to 2^{k} bins, whereas k<n). In such a case the dynamic range can include even less than 2^{k} possible pixel values.

The image converter 26 can perform various image conversions that differ by their complexity and their power consumption. Conveniently, a linear image conversion is simpler and requires less power than a non-linear conversion. The latter conversion usually provides converted images of higher quality.

The conversion that is applied by the image converter 26 is conveniently determined by processor 18.

The backlight driver controller 20 and the backlight driver 22 control the backlight light source 24 and especially its intensity. The intensity is responsive to a backlight illumination parameter that is provided by processor 18. The illumination can be dimmed by a factor that is referred to as a dimming (or boosting) factor.

The temperature input component 34 provides a temperature parameter. This parameter can reflect ambient temperature or the temperature of the display 11. This input component can be a temperature sensor or a component (such as an interface) that receives a temperature parameter from a sensor that is not included within device 10.

The ambient light input component 36 provides an indication about the intensity of the ambient light. It can be a light sensor or a component (such as an interface) that receives the ambient light intensity parameter from a sensor that is not included within device 10.

The image converter 26 provides converted image data to the front frame buffer 28. The LCD controller 32 sends control signals to the display 11 that in turn displays the converted image. The LCD controller 32 is responsive to a control signal from LCD refresh rate controller 30 that in turn determines when to update the display 11.

The LCD refresh rate controller 30 is controlled by the processor 18. The processor 18 determines a maximal refresh rate and a minimal refresh rate in response to ambient temperature or the temperature of the display.

Conveniently, processor 18 also determines if there is a need to update the display, in response to a reception of new image data. The actual refresh rate can be responsive to image data updates.

FIG. 2 illustrates a method 100 for controlling a display, according to an embodiment of the invention.

Method 100 starts by stage 110 of receiving image data. Image data is data the represents an image, such as text, graphics, pictures, multimedia streams on display 11. It is noted that the image data can be of any known color space.

Stage 110 is followed by stage 120 of determining backlight illumination intensity in response to an allowed image degradation level parameter and to ambient light.

According to an embodiment of the invention this stage of determination can also be responsive to an image data type parameter. The image type can be determined by analyzing the histogram of the image and/or by receiving an indication of the type of the image from another component. The other component can be involves in generating the image data, receiving the image over a network and the like. It is noted that high contrast static image can be updated in a much slower rate than color video images. On the other hand edge accentuation more required in low contrast images.

Stage 120 is followed by stage 130 of determining a display refresh parameter in response to a temperature parameter.

Stage 130 can be followed by stage 135 of determining whether to perform a linear image conversion or a non-linear image conversion in response to a power parameter. Conveniently, non-linear image conversion itself requires more power, but provides better visibility under low light conditions as well as under dimmed backlight, and so it could be applied for more aggressive power saving when the battery is nearly empty or user allow some level of visible image distortion.

Stage 135 is followed by stage 140 of converting the image data to provide a converted image data. The determination can be made by processor 18.

According to an embodiment of the invention stage 140 can include defining a conversion function that provides a converted image that is

characterized by substantially uniform brightness distributed histogram.

Conveniently, stage 140 can include generating a normalized sum of grouped image pixel intensities and determining a conversion in response to the normalized sum.

Stage 140 can also include edge accentuation. It is noted that the processor 18 can determine whether to perform the edge accentuation. This can be responsive to a power parameter or to the content of the image data.

Stage 140 is followed by stage 150 of displaying the converted image on a display.

It is noted that the display update (or refresh) is responsive to maximal and minimal display rates (and corresponding minimal and maximal refresh periods Tmin and Tmax), as well as the reception or reception patterns of new image data.

Even if the image data was not changes during a period that exceeds Tmax the 11 display will be refreshed each Tmax. Even if image data has changes within a period that is shorter than Tmin, the update will occur only after at least Tmin from the previous display update. It is further noted that temperature changes that are detected while applying any stage out of stages 110-150 can affect the display update rate.

It is noted that the refresh rate of many LCDs screens is set to 60-70 Hz, while lower refresh rates (such as 30-40 Hz) can provide sufficient image quality.

According to an embodiment of the invention the refresh rate is responsive to temperature levels as well as to the arrival of new image data to the back frame buffer. The arrival of new data is referred to as image data update.

Display refresh rates can be lowered if the image data update rate is low, whereas the display refresh rate can be increased if the image data update rate is high.

For example, if the back frame buffer was updated during a previous refresh cycle then the current refresh cycle starts immediately. If the back buffer frame was not updated during the previous refresh cycle then next refresh cycle can start after a predefined delay. The delay can be responsive to the back frame buffer update pattern, current refresh rate, temperature and the like.

It is noted that the information flow from the back frame buffer to the front frame buffer and then to the display can be optimized such as to reduce power consumptions in various manners. For example, image data shall be transferred only when there changes in the image data provided to the back frame buffer, and can also be minimized only to image portions that were changed. An indication about an image data change can be provided by a processor that executes a certain software, can be provided by a snooping mechanism and the like.

Stage 150 is followed by stage 110.

Conveniently, changes in ambient light intensity or power can affect stages 110 and 120 while changes in ambient temperature can affect stage 130 and 150.

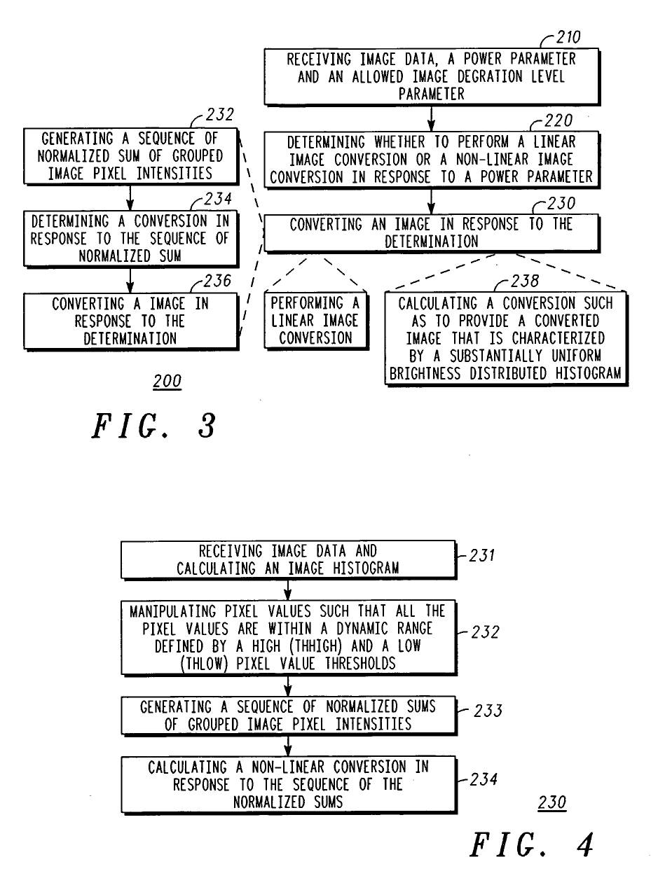

FIG. 3 illustrates a method 200 for controlling a display, according to another embodiment of the invention.

Method 200 starts by stage 210 of receiving image data, a power parameter and an allowed image degradation level parameter.

Stage 210 is followed by stage 220 of determining whether to perform a linear image conversion or a non-linear image conversion in response to a power parameter.

Stage 220 is followed by stage 230 of converting an image in response to the determination.

Conveniently, if method 200 determines to perform a non-linear conversion then stage 230 includes: (i) stage 232 of generating a sequence of normalized sum of grouped image pixel intensities, (ii) stage 234 of determining a conversion in response to the sequence of normalized sum and (iii): stage 236 of applying the conversion.

According to an embodiment of the invention stage 230 comprises stage 238 of calculating a conversion such as to provide a converted image that is characterized by a substantially uniform brightness distributed histogram.

It is noted that a linear image conversion can include determining a pixel amplification factor (also referred to as a boost factor) in response to at least one of the following parameters: backlight intensity reduction, backlight intensity, average pixel brightness, allowed image degradation level and the like. Various prior art linear conversions can be applied.

An exemplary liner conversion is further illustrated by the following equations:

$$\begin{matrix}{R}^{′} = min ( {2}^{k} - 1 , \frac{R ⋆ ( {2}^{k} - 1 )}{THhigh ⋆ ScaleFactor} ) \\ {G}^{′} = min ( {2}^{k} - 1 , \frac{G ⋆ ( {2}^{k} - 1 )}{THhigh ⋆ ScaleFactor} ) \\ {B}^{′} = min ( {2}^{k} - 1 , \frac{B ⋆ ( {2}^{k} - 1 )}{THhigh ⋆ ScaleFactor} ) \\ {P}^{′} = ( Cr ⋆ {R}^{′} ) + ( Cb ⋆ {B}^{′} ) + ( Cg ⋆ {G}^{′} )\end{matrix}$$

Wherein R, B and G are the red, blue and green components of an original pixel, R′, B′ and B′ are the red, blue and green components of a converted pixel, ScaleFactor is a parameter that is responsive to ambient light intensity according to a predefined mapping, THhigh is the upper pixel value threshold, P′ is a converted pixel value, and 2^{k} is the highest pixel value of a truncated histogram that includes 2^{k} bins. The operation min( ) selects a minimal value out of multiple variables.

It is noted that pixel intensities are boosted by a boost factor, while the backlight source is dimmed by substantially the same boost factor. The boost factor can be substantially equal to: (THhigh*ScaleFactor)/(2^{k}−1).

FIG. 4 illustrates a non-linear image conversion process 230 according to an embodiment of the invention.

Process 230 includes stage 231 of receiving image data and calculating an image histogram.

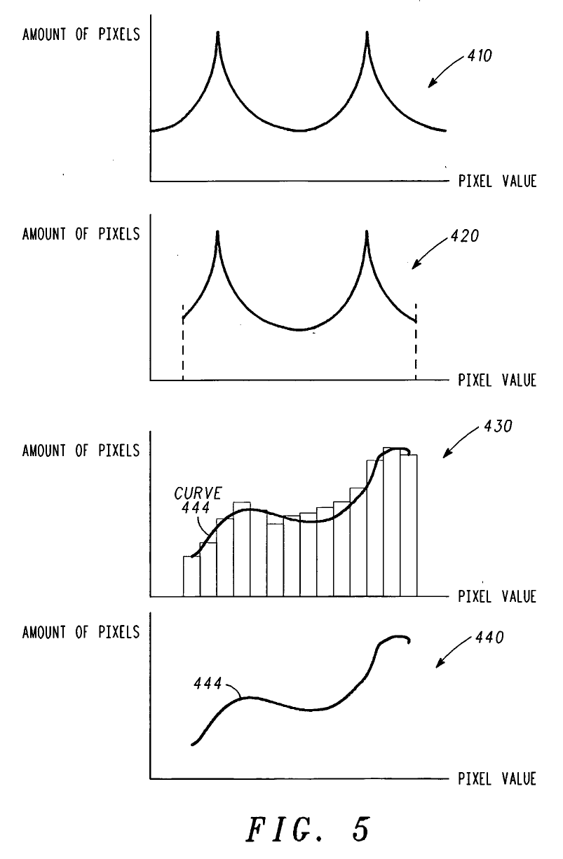

The image histogram may include fewer bins than the possible number of pixel values. The mapping to bins is done by truncating the pixel values. FIG. 5 includes an exemplary histogram 410 that illustrates the distribution of pixel values within the image.

The pixel values are manipulated during stage 232 such that all the pixel values are between a high (THhigh) and low (THlow) pixel value thresholds. FIG. 5 includes an exemplary modified histogram 420 that illustrates the new distribution.

Stage 232 is followed by stage 233 of generating a sequence of normalized sums of grouped image pixel intensities. The normalized sun of each bin is calculated by multiplying the number of pixels per bin by the average value of pixels within that bin. Assuming that there are 2^{k} bins then the sequence includes 2^{k} normalized sums. FIG. 5 includes a graph 430 that represents such a normalized sum.

Stage 233 is followed by stage 234 of calculating a non-linear conversion in response to the sequence of the normalized sums. The non-linear conversion can be calculated by approximating the relationship between pixel values and the corresponding normalized sums. This can include applying extrapolation operations, but this is not necessarily so. Curve 444 of graphs 430 and 440 graphically illustrates such an approximation.

According to another embodiment of the invention the non-linear conversion is defined such as to provide a converted image that is characterized by substantially uniform brightness distributed histogram.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A method for controlling a display, the method comprises:
receiving image data;
determining backlight illumination intensity in response to an allowed image degradation level parameter and to ambient light;
determining a display refresh parameter in response to a temperature parameter.

2. The method according to claim 1 further comprising converting the image data to provide a converted image data.

3. The method according to claim 2 wherein the converting comprises performing a non-linear image conversion.

4. The method according to claim 2 wherein the converting comprises defining a conversion function that provides a converted image that is characterized by substantially uniform brightness distributed histogram.

5. The method according to claim 1 further comprising determining whether to perform a linear image conversion or a non-linear image conversion in response to a power parameter.

6. The method according to claim 5 wherein the determining is followed by converting the image data to provide a converted image data and wherein the converting further comprises edge accentuation.

7. The method according to claim 1 wherein the determining is responsive to an image data type parameter.

8. A method for controlling a display, the method comprises:
receiving image data, a power parameter and an allowed image degradation level parameter; and
determining whether to perform a linear image conversion or a non-linear image conversion in response to a power parameter.

9. The method according to claim 8 further comprising converting an image in response to the determination.

10. The method according to claim 9 wherein a non-linear image conversion comprises generating a normalized sum of grouped image pixel intensities and determining a conversion in response to the normalized sum.

11. The method according to claim 9 further comprising calculating a conversion such as to provide a converted image that is characterized by substantially uniform brightness distributed histogram.

12. A device for controlling a display, the device comprises:
a frame buffer adapted to receive image data and a processor adapted to determine backlight illumination intensity in response to an allowed image degradation level parameter and to ambient light; and
a temperature input component for providing a temperature parameter, wherein the processor is further adapted to determine a display refresh parameter in response to the temperature parameter.

13. The device according to claim 12 further comprising an image converter adapted to convert the image data to provide a converted image data.

14. The device according to claim 13 wherein image converter is adapted to perform a non-linear image conversion.

15. The device according to claim 13 wherein image converter is adapted to perform a conversion function that provides a converted image that is characterized by substantially uniform brightness distributed histogram.

16. The device according to claim 13 wherein the processor is adapted to determine whether to perform a linear image conversion or a non-linear image conversion in response to a power parameter.

17. The device according to claim 16 wherein the image converter is further adapted to perform edge accentuation.

18. The device according to claim 12 further adapted to process the image data to determine at least one image data type parameter and wherein the processor is adapted to determine at least one parameter out of a backlight illumination parameter and a least one image conversion parameter in response to the at least one image data type parameter.

19. A device for controlling a display, the device comprises:
a frame buffer adapted to receive image data, and a processor adapted to receive a power parameter and an allowed image degradation level parameter; and
a image converter that is adapted to perform a linear image conversion and a non-linear image conversion, wherein the processor is adapted to determine which conversion to perform in response to a power parameter.

20. The device according to claim 19, further adapted to generate a normalized sum of grouped image pixel intensities and to determine a conversion in response to the normalized sum.

21. The device according to claim 19, further adapted to calculate a conversion such as to provide a converted image that is characterized by substantially uniform brightness distributed histogram.
